(19) United States
(12) Patent Application Publication
(10) Pub. No.: US 2008/0050504 A1
(43) Pub. Date: Feb. 28, 2008

(54) Anhydrous Resilient Chocolate Chip for Ice Cream Novelty Products

(76) Inventor: Vladimir Miller, Thornhill (CA)

Correspondence Address: GOWAN INTELLECTUAL PROPERTY, 1075 NORTH SERVICE ROAD WEST, SUITE 203, OAKVILLE, ON, L6M-2G2, US

(21) Appl. No.: 11/461,590

(22) Filed: Aug. 1, 2006

(51) Int. Cl. A23G 1/04

(52) U.S. Cl. 426/631

(57) ABSTRACT

Anhydrous resilient chocolate chips for use with ice cream novelty products have a melting curve ranging from 0° C. to 37° C., and comprise 15% to 40% chocolate liquor, 15% to 65% sugar, and 20% 50% fat content. At least 50% fat content has a melting point below 20° C. The fat content may be cocoa butter and butterfat; or it may be mixtures and combinations of chocolate compatible unhydrogenated vegetable oils such as coconut oil, palm kernel oil, canola oil, shea butter, illippe butter, Borneo tallow, soya oil, corn oil, and cottonseed oil, together with 5% to 15% cocoa powder; or it may be up to 90% butterfat together with chocolate compatible unhydrogenated vegetable oils. The cocoa butter and butterfat form a eutectic mixture; and the vegetable oil fat content of the other fat systems has a depressed melting point.

### FIELD OF THE INVENTION

This invention relates to anhydrous resilient chocolate chips that are particularly intended for use with edible ice cream novelty products. The resilient chocolate chips provide an excellent mouth sense and organoleptic properties, with excellent flavor release, and are used to coat the periphery of an ice cream slab in an ice cream sandwich product, or to coat ice cream extending from a cone, or to coat ice cream which is molded onto a stick. The resilient chocolate chips are less brittle and fragile than ordinary baking chocolate chips, have a lower melting point, and may be manufactured from a chocolate liquor and sugar content together with fat content which may or may not include butterfat and/or chocolate compatible unhydrogenated vegetable oils.

### BACKGROUND OF THE INVENTION

Ice cream novelty products having chocolate coatings that have been coated or sprinkled with chocolate chips have been known for many years. Other flavored, sugar and fat based coatings are also known, but the present invention is particularly directed to chocolate chips, and specifically resilient chocolate chips that lack the brittle or fragile characteristics of the known chocolate chips which are typically the same as those which are used for baking purposes.

The present invention is particularly directed to ice cream novelty products that are coated with chocolate chips, and as such are so-called “premium” ice cream novelty items. Thus, the present invention is directed to that part of the market that concerns itself with high quality ice cream novelty items that are sold at relatively high prices, and which are comprised of high quality, top grade materials. Such items are typically ice cream sandwiches where a slab of ice cream is placed between two biscuits and the periphery of the ice cream slab is coated with chocolate chips, or ice cream cones where that part of the ice cream which extends from a cone is coated with chocolate chips, or ice cream bars where ice cream is molded onto a stick and the periphery of the ice cream is coated with chocolate chips.

Typically, lower priced ice cream novelty items may have as much as 30% to 40% of their volume comprised of air—the ice cream being a high over-run product. Moreover, such low priced ice cream novelty items are very often made from ice cream or, indeed, ice milk, which has a low fat content. While such products may be favored by certain sectors of the market because of their low caloric content, they are also less attractive because they have less flavor, or artificially enhanced flavors. Premium novelty ice cream items, on the other hand, generally have less than about 30% volume by air, and have a much higher fat content in the ice cream.

In either event, however, if the novelty ice cream item is coated with a chocolate coating, the chocolate coating may be almost the same. While such coatings are called “chocolate” coatings, in fact they are not pure chocolate coatings. At least in North America, dispensations have been received from Governmental agencies responsible for the quality and labelling of food items to label the coating as being “chocolaty”, even though the coating may comprise a high percentage by weight of vegetable oil.

The melting point of chocolate is very high, being well above room temperature; and in some instances, the melting point of chocolate may be above mouth temperature. Thus, attempts have been made to provide in the chocolate coatings with depressed melting points to compensate for the high melting point of chocolate by adding vegetable oils and the like; and in Canada and United States, such products may be labeled as being “chocolaty” coatings. However, the same approach to chocolate chips used to coat ice cream novelty products has thus far failed, so that the brittleness of chocolate chips is noticeable and detracts from a pleasant mouth sense. Moreover, organoleptic properties including flavor release are not fully satisfactory when hard chocolate chips are utilized.

The present inventor has quite surprisingly determined that not only is it possible to provide resilient chocolate chips with a lower melting point so as to avoid brittleness and to present more pleasing organoleptic properties, it is possible to do so with a variety of fat systems which may comprise butterfat, chocolate compatible vegetable oils, or both. When only butterfat is employed, then cocoa butter will also be employed, so that the composition has two fat systems—the cocoa butter and butterfat—which will form a eutectic mixture. On the other hand, if chocolate compatible vegetable oil or oils are employed, with or without butterfat, then at least the vegetable oil fat content of the composition will have a depressed melting point. In all events, and keeping with the present invention as will be described hereafter, at least 50% of the fat content of the resilient chocolate chip composition will have a melting point below 20° C.

By providing an anhydrous resilient chocolate chip which may be used in association with novelty ice cream products, the resiliency of the chocolate chips means that they will have a more controlled and gentle snap, with less brittleness, and therefore offer a better mouth sense and flavor release. It is also permissible for the manufacturer of the ice cream novelty product who employs the anhydrous resilient chocolate chips of the present invention to state that the ice cream novelty product includes chocolate chips as one of its constituents. Indeed, “pure chocolate” is such that it may have only butterfat together with cocoa butter as the fat system; but the present invention also provides for the use of chocolate compatible vegetable oils which are such that the resulting product may be designated as “chocolaty” chips.

It should also be noted that the present invention differs significantly from chocolate compound confectionery coatings which typically comprise from 5% 15% of cocoa powder, from 30% to 65% of sugar, and from 20% to 40% of fat content. In contrast thereto, the present invention employs chocolate liquor in an amount up to 40%, and a fat content in an amount up to 50%.

It will be noted hereafter that the anhydrous resilient chocolate chips of the present invention may typically be dark chocolate, but may also be milk chocolate—being a chocolate which includes milk ingredients.

### DESCRIPTION OF THE PRIOR ART

MILLER U.S. Pat. No. 5,591,474 issued Jan. 7, 1997, provides a method of preparation of chocolate crumb. That patent teaches an anhydrous chocolate crumb where anhydrous butter fat may be added to a dried mix so as to provide a final analysis for the total amount of dried milks and anhydrous butter fat up to specified amounts.

Another patent to MILLER, U.S. Pat. No. 5,672,373 issued Sep. 30, 1997 provides a method of producing anhydrous whole milk powder having full fat recovery for further use. There, the anhydrous milk powder is added back to dried skim milk in designated quantities, and blended so as to have the same constituent make-up of ordinary dry whole milk, but wherein all of the fat constituent is recoverable as fat. That anhydrous milk powder is particularly intended for use by the chocolate industry, in the manufacture of milk chocolate; although it may also be used in the manufacture of dry baking mixes or other prepared foods where dried milk powder is not to be re-hydrated.

WARKENTIN U.S. Pat. No. 3,959,516 issued May 25, 1976 teaches a classic method for producing a solid chocolate composition which is suitable for coating ice cream. Here, cocoa powder is milled, with or without an additional chocolate liquor, but together with sugar, hydrogenated vegetable oil, salt, lecithin, and optionally whey powder or low fat milk powder. The purpose is to provide wafers of chocolate which have a softening point of about 100.degree. F., which solid chocolate wafers are easily handled. When a chocolate coating for ice cream is intended to be made, the wafers are stirred into warm vegetable oil, having a temperature of about 110° to 130° F., in the ratio of approximately 50% by weight of solid chocolate wafers and about 50% by weight of warm vegetable oil. Obviously, the chocolate coating composition which is thus prepared has a very high vegetable oil constituent. Thus, while the chocolate coating is referred to as such, it is not, in fact, pure chocolate.

CAIN et al., in U.S. Pat. No. 5,858,427 issued Jan. 12, 1999, teach a flexible ice cream coating composition which is intended to be used, for example, in coating an ice cream cone into which ice cream will later be placed. The coating may have a high unsaturated fat constituency, but it is in any event made from oils such as palm oil, shea, lillipe, together with cocoa butter or factions thereof, along with sunflower oil, maize oil, soyabean oil, olive oil, safflower oil, or canola oils.

U.S. Pat. No. 5,556,659 issued Sep. 17, 1996 to DePEDRO et al. teaches a reduced-calorie coated frozen confectionery. Here, the coating is a water-in-oil emulsion which contains up to 55% by weight of water.

In U.S. Pat. No. 6,488,971 issued Dec. 3, 2002, the present inventor, and others, provides a resilient pure chocolate coating composition for novelty ice cream products, which has a melting point above 0° C. and below 20° C. The coating comprises 15% to 50% of chocolate liquor and cocoa butter, 15% to 40% of sugar, and 15% to 50% of butterfat. Up to 30% milk ingredients may also be employed. The chocolate coating composition is a eutectic composition, having the cocoa butter fat system and the butterfat system; and provides a better mouth sense and organoleptic properties.

United States Patent Application Publication US 2006/0093708, published May 4, 2006 in the name of YASEEN et al, teaches an ice cream novelty product which has two biscotti baked goods, each approximately 0.25 inch thick, with approximately 0.75 inch ice cream slab between them. On the surface of each biscotti layer which comes into contact with the ice cream there is a layer of thin, couverture chocolate which is a combination of chocolate liquor and cocoa butter in the range of 33% to 36% cocoa butter with the rest being chocolate liquor.

JONES U.S. Pat. No. 4,644,901 issued Feb. 24, 1987, teaches an apparatus for making chocolate-coated ice cream cookie sandwiches, comprising an ice cream brick slicing machine and a chocolate coating machine. A pass-through freezer is used prior to the chocolate coating. The purpose is to avoid a soggy taste of the manufactured ice cream cookie sandwich.

### SUMMARY OF THE INVENTION

In accordance with one aspect of the present invention, there is provided an anhydrous resilient chocolate chip for use with edible ice cream novelty products, which has a melting curve ranging from 0° C. to 37° C., and which comprises:

15% to 40% chocolate liquor

15% to 65% sugar

20% to 50% fat content

At least 50% of the fat content has a melting point below 20° C.

The fat content is chosen from the group consisting of (a) cocoa butter and butterfat, (b) chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder, and (c) up to 90% butterfat together with any of the group of chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder.

When the fat content is cocoa butter and butterfat, the cocoa butter and butterfat form a eutectic mixture; and when the fat content comprises chocolate compatible unhydrogenated vegetable oil or oils, the vegetable oil fat content has a depressed melting point.

Representative SFI characteristics for various cocoa butter:butterfat eutectic mixtures are as follows:

### SFI Index of Cocoa Butter: Butterfat Eutectic Mixtures

| | 80:20 | 50:50 | 20:80 |
|---|---|---|---|
| 10° C. | 75% | 55% | 60% |
| 21.1° C. | 60% | 34% | 18% |
| 28.9° C. | 50% | 27% | 13% |
| 33.3° C. | 25% | 10% | 4% |
| 40° C. | 0% | 0% | 0% |

Representative SFI characteristics for chocolate compatible unhydrogenated vegetable oils together with 5% to 15% cocoa powder are as follows:

### Typical SFI Index of Chocolate Compatible Unhydrogenated Vegetable Oils with Cocoa Powder

| | Fractionated Palm | | | | |
|---|---|---|---|---|---|
| | Kernel | | | | Coconut |
| | Oil - 100% | 80:20 | 50:50 | 20:80 | Oil 100% |
| 10° | 70% | 66 ± 2% | 62 ± 2% | 58 ± 2% | 55 ± 3% |
| 23.1° | 64 ± 2% | 62 ± 2% | 47 ± 2% | 36 ± 2% | 30 ± 2% |
| 28.9° | 25 ± 2% | 40 ± 2% | 26 ± 2% | 11 ± 2% | 0 |
| 32.3° | 17 ± 2% | 13 ± 2% | 8 ± 2% | 0 | 0 |
| 40° | 2 ± 2% | 0 | 0 | 0 | 0 |

Finally, representative SFI characteristics for chocolate compatible unhydrogenated vegetable oils together with up to 90% butterfat are as follows:

### Typical SFI Index of Chocolate Compatible Unhydrogenated Vegetable Oils with up to 90% Butterfat and Cocoa Powder

| | Butterfat | 80:20 | 50:50 | 20:80 | Canola Oil |
|---|---|---|---|---|---|
| 10° | 40 ± 5% | 34 ± 5% | 22 ± 5% | 8 ± 3% | 0% |
| 23.1° | 15 ± 5% | 16 ± 5% | 11 ± 5% | 5 ± 3% | 0% |
| 28.9° | 9 ± 3% | 7 ± 3% | 5 ± 3% | 2 ± 1% | 0% |
| 32.3° | 3 ± 1% | 0% | 0% | 0% | 0% |
| 40° | 0% | 0% | 0% | 0% | 0% |

As noted, anhydrous resilient chocolate chips in keeping with the present invention may be milk chocolate, and may further comprise up to 30% milk ingredients.

Anhydrous resilient chocolate chips in keeping with the present invention may further comprise up to 1% lecithin.

An ice cream novelty product is contemplated, which comprises an ice cream core and a plurality of anhydrous resilient chocolate chips in keeping with the present invention adhered to at least a surface of the ice cream core.

The ice cream novelty product may have a slab of ice cream having planar top and bottom surfaces and having biscuits adhered thereto, and at least the periphery of the ice cream core has a plurality of anhydrous resilient chocolate chips in keeping with the present invention adhered thereto.

Alternatively, the ice cream novelty product may have an ice cream core that is placed in a cone, and at least a portion of the periphery of the ice cream core extending from the cone has a plurality of anhydrous resilient chocolate chips in keeping with the present invention adhered thereto.

Still further the ice cream novelty product may have an ice cream core that has been molded onto a stick, and the periphery of the ice cream core has been rolled in a container of anhydrous resilient chocolate chips so as to adhere a plurality of anhydrous resilient chocolate chips in keeping with the present invention thereto.

The present invention provides a method of making ice cream novelty products, which method comprises the following steps:

(a) preparing the ice cream core and dispensing the same onto a biscuit, into a cone, or onto a stick, and maintaining the prepared ice cream core at a temperature below −5° C.;

(b) adhering a plurality of anhydrous resilient chocolate chips in keeping with the present invention to at least a portion of the periphery of the ice cream core by rolling or dipping the ice cream core into a container of the anhydrous resilient chocolate chips, the step being carried out at a temperature in the range of −20° C. to +5° C.; and

(c) maintaining the product of step (b) at a temperature below −5° C. for storage, shipping, and handling.

Finally, the present invention also provides a method of making discrete anhydrous resilient chocolate chips for use with edible ice cream novelty products, where the resilient chocolate chips are as described above, having a melting curve ranging from 0° C. to 37° C., and the following major constituents:

15% to 40% chocolate liquor

15% to 65% sugar

20% to 50% fat content

Of course, the fat content is as described above, being one of (a) cocoa butter and butterfat, (b) chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder, and (c) up to 90% butterfat together with any of the group of chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder.

The method comprises the following steps:

(d) Mixing the chocolate liquor and the sugar components together, and optionally the fat content, and heating the mixture to at least 40° C.

(e) In the event that the fat content has not been mixed with the chocolate liquor and the sugar components before heating to at least 40° C., adding the fat content to the chocolate liquor and the sugar components after they have been heated to at least 40° C.

(f) Conching the heated mixture of chocolate liquor, sugar, and fat content, until a predetermined particle size and viscosity thereof have been achieved.

(g) Cooling the conched mixture to a temperature in the range of −10° C. to +10° C.

(h) Molding to the cooled mixture into discrete anhydrous chocolate chips.

(i) Cooling the discrete anhydrous chocolate chips to a temperature below −5° C.

(j) Maintaining the cooled discrete anhydrous chocolate chips at a temperature below −5° C. for further storage, shipping, and handling.

When the discrete anhydrous resilient chocolate chips are milk chocolate they may further comprise up to 30% milk ingredients, and in that the case the method provides that the milk ingredients are added before step (f).

### DETAILED DESCRIPTION OF THE INVENTION

The novel features which are believed to be characteristic of the present invention, as to its structure, organization, use and method of operation, together with further objectives and advantages thereof, will be better understood from the following discussion.

By providing a resilient chocolate chip composition that may be employed for coating novelty ice cream items, the present invention requires that the resilient chocolate chip shall have a melting curve which ranges from 0° C. to 37° C. As noted, the composition of the anhydrous resilient chocolate chip products comprises from 15% to 40% of chocolate liquor, from 15% to 65% of sugar, and from 20% to 50% of fat content.

It is important to note that in keeping with the present invention, at least 50% of the fat content has a melting point below 20° C.

It should be noted that the chocolate composition of the resilient chocolate chips of the present invention will have a melting point which is no lower than the freezing point of water but which may range up to 37° C., well above room temperature. However, the present invention provides that at least 50% of the fat content has a melting point below 20° C.; and most of the triglycerides which comprise the fat content will be soft below 10° C. so as to provide a mouth sense and organoleptic properties which provide for a pleasant eating experience without the hardness or brittleness which might otherwise be expected from chocolate chips, and with a pleasant flavor release.

On the other hand, the SFI characteristics of the present invention are such that typically the chocolate composition will be totally liquefied at a temperature above about 38° C. so that there are no crystal nuclei in the liquid composition. For that reason, as will be noted hereafter, the present invention provides for the constituents of the chocolate composition to be heated to at least 40° C. during the manufacturing process.

Moreover, the present invention recognizes that the manufactured chocolate chips are resilient, and therefore they are typically maintained at a temperature of below −5° C. for storage, shipping, and handling.

Unlike current practice, it is not necessary for the chocolate composition which is employed in the manufacture of resilient chocolate chips to contain lecithin. However, if lecithin is used, then it is generally present an amount less than 1%; and if it is used, then it acts as a scavenger so as to bind any free water which may be present in the fat/sugar system; and thereby to ensure the anhydrous properties of the manufactured chocolate chips.

Of course, it has been noted that the present invention also provides that the chocolate composition may be milk chocolate; and in that case, up to 30% milk ingredients may be added to the composition.

The fat system of the present invention may comprise (a) cocoa butter and butterfat; or (b) it may comprise chocolate compatible unhydrogenated vegetable oils that are typically chosen from the group which consists of coconut oil, palm kernel oil, canola oil, shea butter, illippe butter, Borneo tallow, soya oil, corn oil, cottonseed oil, and mixtures and combinations thereof, together with 5% to 15% cocoa powder; or further alternatively the fat system may comprise up to 90% butterfat together with any of the group of chocolate compatible unhydrogenated vegetable oils as described immediately above, and also together with 5% to 15% cocoa powder. Thus, chocolate flavor is imparted to the composition either by way of the chocolate liquor together with cocoa butter, or the chocolate liquor together with cocoa powder.

It now becomes important to note that when the fat content is cocoa butter and: butterfat, then they will form a eutectic mixture. On the other hand, the other two alternative fat systems which comprise chocolate compatible unhydrogenated vegetable oil or oils, and may also comprise butterfat, shall have a depressed melting point.

Typical representative SFI characteristics for the various fat systems are as follows:

### SFI Index of Cocoa Butter: Butterfat Eutectic Mixtures

| | 80:20 | 50:50 | 20:80 |
|---|---|---|---|
| 10° C. | 75% | 55% | 60% |
| 21.1° C. | 60% | 34% | 18% |
| 28.9° C. | 50% | 27% | 13% |
| 33.3° C. | 25% | 10% | 4% |
| 40° C. | 0% | 0% | 0% |

### Typical SFI Index of Chocolate Compatible Unhydrogenated Vegetable Oils with Cocoa Powder

| | Fractionated | | | | |
|---|---|---|---|---|---|
| | Palm Kernel | | | | Coconut Oil |
| | Oil - 100% | 80:20 | 50:50 | 20:80 | 100% |
| 10° | 70% | 66 ± 2% | 62 ± 2% | 58 ± 2% | 55 ± 3% |
| 23.1° | 64 ± 2% | 62 ± 2% | 47 ± 2% | 36 ± 2% | 30 ± 2% |
| 28.9° | 25 ± 2% | 40 ± 2% | 26 ± 2% | 11 ± 2% | 0% |
| 32.3° | 17 ± 2% | 13 ± 2% | 8 ± 2% | 0% | 0% |
| 40° | 2 ± 2% | 0% | 0% | 0% | 0% |

Of course, other chocolate compatible unhydrogenated vegetable oils may be employed, as noted above, and if so the SFI Index may vary somewhat from that which is noted immediately above. On the other hand, as noted hereafter, those skilled in the art relating to dairy fats and vegetable fats including cocoa butter will know that other formulations employing any or all of the chocolate compatible unhydrogenated vegetable oils noted above will yield SFI Indices which will indicate relatively high crystalline content at 10° C., and very little—preferably 0%—crystalline content at or above 40° C.

When butterfat and chocolate compatible unhydrogenated vegetable oils are employed, then up to 90% butterfat may be used, yielding SFI Indices has shown below, with a comparison to 100% butterfat and a comparison to 100% canola oil being also shown for purposes of reference.

### Typical SFI Index of Chocolate Compatible Unhydrogenated Vegetable Oils with up to 90% Butterfat and Cocoa Powder

| | Butterfat | 80:20 | 50:50 | 20:80 | Canola Oil |
|---|---|---|---|---|---|
| 10° | 40 ± 5% | 34 ± 5% | 22 ± 5% | 8 ± 3% | 0% |
| 23.1° | 15 ± 5% | 16 ± 5% | 11 ± 5% | 5 ± 3% | 0% |
| 28.9° | 9 ± 3% | 7 ± 3% | 5 ± 3% | 2 ± 1% | 0% |
| 32.3° | 3 ± 1% | 0% | 0% | 0% | 0% |
| 40° | 0% | 0% | 0% | 0% | 0% |

It will easily be recognized by those skilled in the arts relating to dairy fats and vegetable fats including cocoa butter, that the SFI characteristics for any particular formulation in which palm kernel oil or other chocolate compatible vegetable oils are employed can be calculated, provided that the relationship between the quantity of long chain vegetable oils and short chain vegetable oils is respected. Specifically, the present invention requires that at least 50% of the fat content must have a melting point below 20° C.

Thus, the anhydrous resilient chocolate chips as they have so far been described have a formulation which is specifically intended to provide fat systems which are such that most of the triglycerides are softer at the point of the eating, as will be understood from a study of the typical SFI Index properties noted above. Specifically, the anhydrous resilient chocolate chips are formulated to give a pleasant mouth sense and organoleptic properties, when they are consumed in association with ice cream novelty products for which they have been employed to coat or cover at least a portion of the periphery of the ice cream core of the novelty ice cream products.

As described above, typical ice cream novelty products that are contemplated by the present invention fall into three general categories. First, the ice cream novelty product may be essentially an ice cream sandwich having a slab of ice cream as its ice cream core, where the slab has planar top and bottom surfaces and has biscuits adhered thereto. At least the periphery of the ice cream core has a plurality of anhydrous resilient chocolate chips in keeping with the present invention adhered thereto.

Another form of ice cream novelty product as contemplated by the present invention comprises an ice cream core which is placed into a cone, where at least a portion of the periphery of the ice cream core which extends from the cone has a plurality of anhydrous resilient chocolate chips in keeping with the present invention adhered thereto.

A further alternative ice cream novelty product as contemplated by the present invention comprises an ice cream core that has been molded onto a stick, where the periphery of the ice cream core has been rolled into a container of anhydrous resilient chocolate chips in keeping with the present invention so as to adhere a plurality of the resilient chocolate chips to the periphery of the ice cream core.

Thus, in keeping with another provision of the present invention, there is provided a method of making an ice cream novelty product whereby the following steps are carried out:

(a) First, the ice cream core is prepared and dispensed onto a biscuit, or into a cone, or onto a stick. The thus prepared ice cream core is maintained at a temperature below −5° C.

(b) Then, a plurality of anhydrous resilient chocolate chips in keeping with the present invention is adhered to at least a portion of the periphery of the ice cream core by rolling or dipping the ice cream core into a container of anhydrous resilient chocolate chips, the process being carried out at a temperature which is in the range of −1° C. up to a +5° C.

(c) Finally, the product of the previous step is maintained at a temperature below −5° C. for storage, shipping, and handling.

The following steps are carried out to manufacture discrete anhydrous resilient chocolate chips in keeping with the present invention, and as described above with respect to their composition, their fat content, and the representative SFI characteristics for the various elected fat systems.

(d) First, the chocolate liquor and sugar components are mixed together, and optionally the fat content may also be mixed into the composition at this stage, and the mixture is heated to at least 40° C.

(e) In the event that the fat content has not been mixed with the chocolate liquor and sugar components before they were heated, then the fat content is added to the heated chocolate liquor and sugar components after they have been heated to at least 40° C.

(f) Then, the heated mixture is conched until a predetermined particle size and viscosity have been achieved. As will be known to those skilled in the chocolate industry, a higher viscosity product will result from smaller particle size.

(g) In any event, the conched mixture is then cooled to a temperature which is in the range of −10° C. to +10° C.

(h) After that, the cooled mixture is molded into discrete anhydrous chocolate chips. The molding process is, of course, well known to those skilled in the chocolate arts.

(i) After the molding process, the discrete anhydrous chocolate chips are cooled to a temperature below −5° C.

(j) Thereafter, the cooled discrete who anhydrous chocolate chips are maintained at a temperature below −5° C., for further storage, shipping, and handling.

If the molded anhydrous resilient chocolate chips are to be milk chocolate, further comprising up 30% milk ingredients, then the milk ingredients are added before step (f).

There has been described anhydrous resilient chocolate chip compositions, the molded discrete chocolate chips that are manufactured therefrom, ice cream novelty products employing the molded discrete chocolate chips, typical methods for making the ice cream novelty products, and particularly a method for manufacturing anhydrous resilient chocolate chips in keeping with the present invention. It is noted that in any event, the anhydrous resilient chocolate chips have a depressed melting point so as to provide a pleasant mouth sense and flavor release. The resilient chocolate chips in keeping with the present invention avoid the snap and brittleness of well known, ordinary chocolate chips of the sort that are typically used for baking purposes. Because the anhydrous resilient chocolate chips of the present invention are employed for use in association with ice cream novelty products, they must always be kept at low temperatures and yet they must provide a pleasant and acceptable mouth sense and organoleptic properties. Moreover, the compositions of the anhydrous resilient chocolate chips in keeping with the present invention are such that they may be labelled as being “chocolaty”.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or comprising, will be understood to imply the inclusion of a stated integer or step or group of integers or steps but not to the exclusion of any other integer or step or group of integers or steps.

1. An anhydrous resilient chocolate chip for use with edible ice cream novelty products, said resilient chocolate chip having a melting curve ranging from 0° C. to 37° C., and comprising:
15% to 40% chocolate liquor
15% to 65% sugar
20% to 50% fat content
wherein at least 50% of the fat content has a melting point below 20° C.;
wherein said fat content is chosen from the group consisting of (i) chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder, and (ii) up to 90% butterfat together with any of the group of chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder;
wherein when said fat content comprises either of (i) chocolate compatible unhydrogenated vegetable oil or oils chosen from the group consisting of coconut oil, palm kernel oil, canola oil, shea butter, illippe butter, Borneo tallow, soya oil, corn oil, cottonseed oil, and mixtures thereof, together with 5% to 15% cocoa powder, and (ii) up to 90% butterfat together with any of said group of chocolate compatible unhydrogenated vegetable oils chosen from the group consisting of coconut oil, palm kernel oil, canola oil, shea butter, illippe butter. Borneo tallow, soya oil, corn oil, cottonseed oil, and mixtures thereof, together with 5% to 15% cocoa powder, said vegetable oil fat content has a depressed melting point relative to that of chocolate;
wherein SFI profiles of chocolate compatible unhydrogenated vegetable oils together with 5% to 15% cocoa powder mixtures having specific mixture ratios of fractionated palm kernel oil and coconut oil are as follows:
SFI Profiles of Chocolate Compatible Unhydrogenated Vegetable Oils with Cocoa Powder

| | Fractionated | | | | |
|---|---|---|---|---|---|
| | Palm | | | | Coconut |
| | Kernel Oil- | | | | Oil |
| | 100% | 80:20 | 50:50 | 20:80 | 100% |
| 10° C. | 70% | 66 ± 2% | 62 ± 2% | 58 ± 2% | 55 ± 3% |
| 23.1° C. | 64 ± 2% | 62 ± 2% | 47 ± 2% | 36 ± 2% | 30 ± 2% |
| 28.9° C. | 25 ± 2% | 40 ± 2% | 26 ± 2% | 11 ± 2% | 0% |
| 32.3° C. | 17 ± 2% | 13 ± 2% | 8 ± 2% | 0% | 0% |
| 40° C. | 2 ± 2% | 0% | 0% | 0% | 0% |

wherein the SFI Profiles of other mixture ratios of fractionated palm kernel oil and coconut oil between 100:0 and 0:100, and at any temperature between 10° C. and 40° C., can be interpolated from the ratios shown in the table above:
wherein SFI profiles of chocolate compatible unhydrogenated vegetable oils together with up to 90% butterfat having specific mixture ratios of fractionated butterfat and canola oil are as follows:
SFI Profiles of Chocoatle Compatible Unhydrogenated Vegetable Oils with up to 90% Butterfat and Cocoa Powder

| | Butterfat | 80:20 | 50:50 | 20:80 | Canola Oil |
|---|---|---|---|---|---|
| 10° C. | 40 ± 5% | 34 ± 5% | 22 ± 5% | 8 ± 3% | 0% |
| 23.1° C. | 15 ± 5% | 16 ± 5% | 11 ± 5% | 5 ± 3% | 0% |
| 28.9° C. | 9 ± 3% | 7 ± 3% | 5 ± 3% | 2 ± 1% | 0% |
| 32.3° C. | 3 ± 1% | 0% | 0% | 0% | 0% |
| 40° C. | 0% | 0% | 0% | 0% | 0% |

and wherein the SFI Profiles of other mixture ratios of up to 90% butterfat and canola oil between 100:0 and 0:100, and at any temperature between 10° C. and 40° C., can be interpolated from the ratios shown in the table above.

2. The anhydrous resilient chocolate chip of claim 1, wherein said anhydrous resilient chocolate chip is milk chocolate, and further comprises up to 30% milk ingredients.

3. The anhydrous resilient chocolate chip of claim 1, further comprising up to 1% lecithin.

4. An ice cream novelty product comprising an ice cream core and a plurality of anhydrous resilient chocolate chips as claimed in claim 1, adhered to at least a surface of said ice cream core.

5. The ice cream novelty product of claim 4, wherein said ice cream core is a slab of ice cream having planar top and bottom surfaces and having biscuits adhered thereto, and wherein at least the periphery of said ice cream core has a plurality of anhydrous resilient chocolate chips adhered thereto.

6. The ice cream novelty product of claim 4, wherein said ice cream core is placed in a cone, and at least a portion of the periphery of the ice cream core extending from said cone has a plurality of anhydrous resilient chocolate chips adhered thereto.

7. The ice cream novelty product of claim 4, wherein said ice cream core has been molded onto a stick, and the periphery of said ice cream core has been rolled in a container of anhydrous resilient chocolate chips so as to adhere a plurality of anhydrous resilient chocolate chips thereto.

8. A method of making an ice cream novelty product as claimed in claim 4, said method comprising the following steps:
(a) preparing said ice cream core and dispensing the same onto a biscuit, into a cone, or onto a stick, and maintaining said prepared ice cream core at a temperature below −5° C.;
(b) adhering a plurality of anhydrous resilient chocolate chips to at least a portion of the periphery of said ice cream core by rolling or dipping said ice cream core into a container of said anhydrous resilient chocolate chips, said step being carried out at a temperature in the range of −20° C. to +5° C.; and
(c) maintaining the product of step (b) at a temperature below −5° C. for storage, shipping, and handling.

9. A method of making discrete anhydrous resilient chocolate chips for use with edible ice cream novelty products, said resilient chocolate chips having a melting curve ranging from 0° C. to 37° C., and comprising:
15% to 40% chocolate liquor
15% to 65% sugar
20% to 50% fat content
wherein at least 50% of the fat content has a melting point below 20° C.;
wherein said fat content is chosen from the group consisting of (a) cocoa butter and butterfat, (b) chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder, and (c) up to 90% butterfat together with any of the group of chocolate compatible unhydrogenated vegetable oils chosen from the group consisting of coconut oil, palm kernel oil, canola oil, shea butter, illippe butter, Borneo tallow, soya oil, corn oil, cottonseed oil, and mixtures and combinations thereof, together with 5% to 15% cocoa powder;
wherein, when said fat content is cocoa butter and butterfat, said cocoa butter and butterfat form a eutectic mixture; and wherein, when said fat content is chocolate compatible unhydrogenated vegetable oil or oils, said vegetable oil fat content has a depressed melting point;
wherein representative SFI characteristics for various cocoa butter:butterfat eutectic mixtures are as follows:
SFI Index of Cocoa Butter: Butterfat Eutectic Mixtures

| | 80:20 | 50:50 | 20:80 |
|---|---|---|---|
| 10° C. | 75% | 55% | 60% |
| 21.1° C. | 60% | 34% | 18% |
| 28.9° C. | 50% | 27% | 13% |
| 33.3° C. | 25% | 10% | 4% |
| 40° C. | 0% | 0% | 0% |

wherein representative SFI characteristics for chocolate compatible unhydrogenated vegetable oils together with 5% to 15% cocoa powder are as follows:
Typical SFI Index of Chocolate Compatible Unhydrogenated Vegetable Oils with Cocoa Powder

| | Fractionated | | | | |
|---|---|---|---|---|---|
| | Palm Kernel | | | | Coconut Oil |
| | Oil - 100% | 80:20 | 50:50 | 20:80 | 100% |
| 10° | 70% | 66 ± 2% | 62 ± 2% | 58 ± 2% | 55 ± 3% |
| 23.1° | 64 ± 2% | 62 ± 2% | 47 ± 2% | 36 ± 2% | 30 ± 2% |
| 28.9° | 25 ± 2% | 40 ± 2% | 26 ± 2% | 11 ± 2% | 0% |
| 32.3° | 17 ± 2% | 13 ± 2% | 8 ± 2% | 0% | 0% |
| 40° | 2 ± 2% | 0% | 0% | 0% | 0% |

and wherein representative SFI characteristics for chocolate compatible unhydrogenated vegetable oils together with up to 90% butterfat are as follows:
Typical SFI Index of Chocolate Compatible Unhydrogenated Vegetable Oils with up to 90% Butterfat and Cocoa Powder

| | Butterfat | 80:20 | 50:50 | 20:80 | Canola Oil |
|---|---|---|---|---|---|
| 10° | 40 ± 5% | 34 ± 5% | 22 ± 5% | 8 ± 3% | 0% |
| 23.1° | 15 ± 5% | 16 ± 5% | 11 ± 5% | 5 ± 3% | 0% |
| 28.9° | 9 ± 3% | 7 ± 3% | 5 ± 3% | 2 ± 1% | 0% |
| 32.3° | 3 ± 1% | 0% | 0% | 0% | 0% |
| 40° | 0% | 0% | 0% | 0% | 0% |

said method comprising the steps of:
(d) mixing said chocolate liquor and said sugar components together, and optionally said fat content, and heating said mixture to at least 40° C.;
(e) in the event that said fat content has not been mixed with said chocolate liquor and said sugar components before heating to at least 40° C., adding said fat content to said chocolate liquor and said sugar components after they have been heated to at least 40° C.;
(f) conching said heated mixture of chocolate liquor, sugar, and fat content, until a predetermined particle size and viscosity thereof have been achieved;
(g) cooling the conched mixture to a temperature in the range of −10° C. to +10° C.;
(h) molding to said cooled mixture into discrete anhydrous chocolate chips;
(i) cooling said discrete anhydrous chocolate chips to a temperature below −5° C.; and
(j) maintaining said cooled discrete anhydrous chocolate chips at a temperature below −5° C. for further storage, shipping, and handling.

10. The method of claim 9, wherein said discrete anhydrous resilient chocolate chips are milk chocolate, further comprising up to 30% milk ingredients, and wherein
said milk ingredients are added before step (f).
